(19) United States
(12) Patent Application Publication
(10) Pub. No.: US 2012/0128967 A1
(43) Pub. Date: May 24, 2012

(54) PVC AND STYRENIC ALLOY DECKING WITH REDUCED SURFACE STRESS ACCUMULATION

(75) Inventors: Garry Glenn Belcher, JR., Greensboro, NC (US); John S. Ammondson, Jamestown, NC (US)

(73) Assignee: VIKING POLYMERS, LLC, Jamestown, NC (US)

(21) Appl. No.: 13/299,990

(22) Filed: Nov. 18, 2011

Related U.S. Application Data
(60) Provisional application No. 61/415,086, filed on Nov. 18, 2010.

(51) Int. Cl. B32B 27/00; B32B 3/00; B32B 27/08; B29C 63/00

(52) U.S. Cl. 428/319.3; 264/171.1; 428/500; 428/332; 428/515

(57) ABSTRACT

An extruded structural article with reduced stress whitening is disclosed. The article has a styrenic alloy cap layer that is lightly plasticized to reduce the stress discoloration without degrading properties of the article. A plasticizer is blended with components of the cap layer, and the cap layer co-extruded with a structural core material to form the article.

### CROSS-REFERENCE TO RELATED APPLICATIONS

This application claims the benefit of U.S. Provisional Application No. 61/415,086 filed Nov. 18, 2010, which is incorporated by reference in its entirety.

### FIELD

Embodiments of the invention relate to synthetic structural articles and methods of making synthetic structural articles. More specifically, embodiments described herein relate to durable coatings for structural articles and methods of making them.

### BACKGROUND

Wood structural members are slowly being replaced by synthetic structural members as their relative costs, direct and indirect, converge. Synthetic structural articles such as foam decking, railing, fencing, and siding materials exhibit good strength and usability, and may be capped with a finishing layer to apply colors and textures for a pleasing appearance. Such structural articles are frequently constructed with a PVC or composite core that may or may not be foamed, and a styrenic capping layer that accepts coloring and texturing, and resists weathering.

In some such structural articles, moisture may intrude into the hydrophilic styrenic surface material. Intrusion of moisture disrupts the molecular structure of the surface, introducing stress into the material. The stress causes a whitening discoloration of the surface by refracting light. Although the whitening can be reversed by relieving the stress on the surface of the material, for example with heat, there is a need for a decking material having a styrenic surface that does not exhibit stress discoloration.

### SUMMARY

Embodiments described herein provide a synthetic structural article having a rigid extruded core comprising a polymeric material and a styrenic cap material comprising about 10% or less by weight of a plasticizer or solvent. The plasticizer or solvent additive is blended with polymer components and other additives, and then co-extruded with the core to form a coated structural article. In some embodiments, a tie layer may be inserted between the core and the cap to improve adhesion and/or allow use of a thinner cap layer.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross-sectional view of a structural article according to one embodiment.

FIG. 2 is a cross-sectional view of a structural article according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments described herein provide synthetic structural articles such as decking articles, railing articles, fencing articles, and siding articles, that comprise a rigid polymeric core material and a lightly plasticized capping material. Lightly plasticizing the capping material reduces discoloration of the capping material to due internal stresses from moisture, or other, intrusion. Stress whitening is thought to occur as voids form between phases of polymer blends that comprise a hard glassy matrix encapsulating softer rubber-like domains, or within the rubber-like domains themselves. Under stresses introduced by intruding molecules such as water, due to differences in expansion rates between water and polymer systems, the cavities holding the rubber-like domains expand, while the rubber-like materials are resistant to such expansion. The voids formed thereby scatter light, producing the white color typically observed.

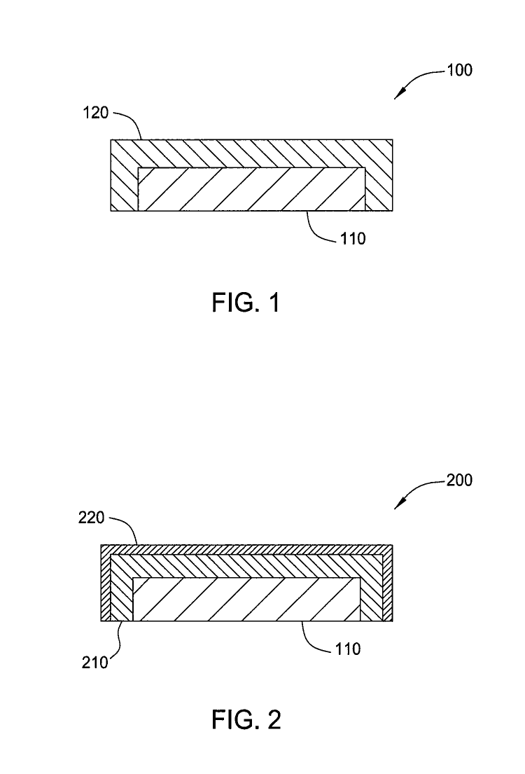

FIG. 1 is a schematic cross-sectional view of an article 100 according to one embodiment. The article 100 is a synthetic structural article that may be used for external wood-replacement applications requiring strong weather resistance, such as fencing, decking, railing, siding, and the like. The article 100 comprises a rigid extruded core 110 and a cap layer 120. The core 110 typically comprises a polymeric material, and may be a solid polymeric material, a cellulosic composite (e.g. with wood or flax fiber), or a foam or gel of either material. Exemplary core materials include, but are not limited to, PVC and polyethylene (PE).

The cap layer 120 comprises a polymeric material selected for weather resistance, texturability, and colorablity. Styrenic materials, acrylic materials, or blends thereof, including blends or alloys of polyvinyl chloride (PVC), chlorinated polyvinyl chloride (CPVC), polystyrene (PS), polyacrylonitrile-butadiene-styrene (ABS), polyacrylate-styrene-acrylonitrile (ASA), and polycarbonate (PC) are typically used for cap layers. In one embodiment, a cap layer comprises about ⅓ PVC and about ⅔ ASA by weight, and may be an alloy.

The cap layer 120 is lightly plasticized to reduce stress discoloration from moisture intrusion. About 10% by weight or less of a plasticizer is blended with the cap layer material to induce enough resiliency to eliminate discoloration from internal stress. Suitable plasticizers may be ethylene terpolymers or ionomers, ethylene-methyl acrylate copolymers, ethylene-methacrylic acid copolymers, thermoplastic polyester-polyurethane, citrates, butyl methacrylate-methacryloyloxyethyltrimethylammonium chloride (BMAC) copolymer, epoxidized soybean oil, chlorinated polyethylene, di-isononyl-cyclohexane dicarboxylate, alkyl or aryl phthalates and terephthalates, and combinations thereof. Exemplary phthalates and terephthalates include, but are not limited to, dioctyl terephthalate, di-isononyl phthalate, di-isobutyl phthalate, di-isodecyl phthalate, dibutyl phthalate, benzylbutyl phthalate, di-2-ethylhexyl phthalate, di-isoheptyl phthalate, di-isoundecyl phthalate, and di-isotridecyl phthalate. Exemplary plasticizers include the ELVALOY® and SURLYN® resins available from DuPont. The cap layer 120 may be between about 3% and about 10% by weight plasticizer, such as between about 3% and about 8%, for example about 6%.

Wishing not to be bound by theory, it is believed that lightly plasticizing the blend imparts a slight malleability to the glassy phase of the polymer blend. This slight malleability, while not observable by macro-scale testing, reduces the tendency of voids to form, or prevents voids from forming or remaining, between the glassy and rubbery domains, and within the rubbery domains, because the grain boundaries and rubbery domains undergo less stress. The glassy matrix is able to relieve the internal stress imparted by intrusion by deforming slightly. It should be noted, in this context, that solvents able to penetrate the hard glassy matrix in relatively low concentrations will also relieve internal stresses.

The core 110 generally has dimensions typical of structural members, such as wood boards used for decking, siding, fencing, and the like. The cap layer 120 is a thin coating layer that may have thickness between about 4 mils and about 30 mils, depending on the application. For a decking article the cap layer 120 may have thickness between about 15 mils and about 30 mils, while for a siding article the cap layer may have thickness between about 4 mils and about 15 mils.

FIG. 2 is a schematic cross-sectional view of an article 200 according to another embodiment. The article 200 is also a structural article usable for similar applications as the article 100 of FIG. 1. The article 200 comprises the rigid core 110, an intermediate layer 210, and a cap layer 220. The intermediate layer 210 may be a cap layer similar to the cap layer 120 of FIG. 1 without plasticizer, or may be a tie layer comprising a bonding material such as any of the resins previously mentioned, or any other resins compatible with the core material, such as PVC or PE. A tie layer is frequently used, for example, with a PE or modified PE core material (foam or solid) to improve adhesion of the cap layer to the core. The cap layer 220 is generally similar to the cap layer 120 of FIG. 1, but may be thinner when a non-plasticized cap layer is used for the intermediate layer 210. For example, if the intermediate layer 210 is a non-plasticized cap layer of thickness about 10 mils, the cap layer 220 may have thickness less than about 4 mils, for example between 1 mil and 4 mils. If the intermediate layer 210 is a tie layer, the tie layer will have thickness between about 5 mils and about 20 mils, such as about 10 mils.

The articles 100 and 200 of FIGS. 1 and 2 are co-extruded articles. The core material may be extruded from PVC foam or extrusion foamed from PVC pellets or powder. The cap layers 120 and 220 may be reactively extruded, depending on the desired blend. A plasticizer, in pellet, powder, or liquid form, is blended with extrusion precursors. A feed blend of between about 25-65 weight percent PVC powder, between about 25-75 weight percent of combined styrene-acrylonitrile (SAN) pellets and acrylic elastomer pellets, and between about 2-10 weight percent plasticizer pellets or powder, with desired pigments, may be extruded at a rate, relative to the core material extrusion rate, that yields the desired thickness of cap layer. Any of the plasticizers listed above may be used in the blend. In addition, the articles 100 and 200 of FIGS. 1 and 2 are shown with layers, i.e. the cap layer 120 or the intermediate and cap layers 210 and 220, covering three sides of the core 110, but alternate embodiments may have layers covering only one side of the core or all four sides of the core (or six sides if the ends of the article are coated).

While the foregoing is directed to embodiments of the invention, other and further embodiments of the invention may be devised without departing from the basic scope thereof.

What is claimed is:

1. A synthetic structural article, comprising:
a rigid extruded core comprising a polymeric material; and
a cap material comprising at least one of a styrenic material and an acrylic material, and about 10% or less by weight of a plasticizer.

2. The synthetic structural article of claim 1, wherein the core comprises a solid or foamed material selected from the group consisting of PVC, PE, PVC composite, PE composite, or combinations thereof.

3. The synthetic structural article of claim 1, wherein the plasticizer is selected from the group consisting of ethylene terpolymers, ethylene-methyl acrylate copolymers, ethylene-methacrylic acid copolymers, thermoplastic polyester-polyurethane, dioctyl terephthalate, di-isononyl phthalate, di-isobutyl phthalate, di-isodecyl phthalate, dibutyl phthalate, benzylbutyl phthalate, citrates, butyl methacrylate-methacryloyloxyethyltrimethylammonium chloride (BMAC) copolymer, epoxidized soybean oil, chlorinated polyethylene, di-2-ethylhexyl phthalate, di-isoheptyl phthalate, di-isoundecyl phthalate, di-isotridecyl phthalate, di-isononyl-cyclohexane dicarboxylate, and combinations thereof.

4. The synthetic structural article of claim 1, wherein the cap material comprises at least about 3% by weight plasticizer.

5. The synthetic structural article of claim 1, wherein the cap material comprises a material selected from the group of ASA, acrylic resin, or combinations thereof.

6. The synthetic structural article of claim 5, wherein the core comprises PVC.

7. The synthetic structural article of claim 1, wherein the cap material has a thickness between about 4 mils and about 30 mils.

8. The synthetic structural article of claim 6, wherein the synthetic structural article is a decking article, a railing article, a siding article, or a fencing article.

9. A method of reducing or preventing stress discoloration in a synthetic structural article, comprising:
co-extruding a structural core and a capping material, the capping material comprising about 10% by weight or less of a plasticizer.

10. The method of claim 9, wherein co-extruding the structural core and the capping material comprises reactively extruding the capping material with the plasticizer.

11. The method of claim 9, wherein co-extruding the structural core and the capping material comprises blending a styrenic polymer, an acrylic polymer, and a plasticizer in a blender and extruding the blend.

12. The method of claim 9, wherein the capping material is extruded to a thickness between about 4 mils and about 30 mils.

13. The method of claim 9, wherein the capping material comprises about 25-65 weight percent PVC, about 25-75 weight percent ASA, and about 3-10 weight percent plasticizer.

14. The method of claim 9, wherein the plasticizer is selected from the group consisting of ethylene terpolymers, ethylene-methyl acrylate copolymers, ethylene-methacrylic acid copolymers, thermoplastic polyester-polyurethane, dioctyl terephthalate, di-isononyl phthalate, di-isobutyl phthalate, di-isodecyl phthalate, dibutyl phthalate, benzylbutyl phthalate, citrates, butyl methacrylate-methacryloyloxyethyltrimethylammonium chloride (BMAC) copolymer, epoxidized soybean oil, chlorinated polyethylene, di-2-ethylhexyl phthalate, di-isoheptyl phthalate, di-isoundecyl phthalate, di-isotridecyl phthalate, di-isononyl-cyclohexane dicarboxylate, and combinations thereof.

15. The method of claim 13, wherein the plasticizer is selected from the group consisting of ethylene terpolymers, ethylene-methyl acrylate copolymers, ethylene-methacrylic acid copolymers, thermoplastic polyester-polyurethane, dioctyl terephthalate, di-isononyl phthalate, di-isobutyl phthalate, di-isodecyl phthalate, dibutyl phthalate, benzylbutyl phthalate, citrates, butyl methacrylate-methacryloyloxyethyltrimethylammonium chloride (BMAC) copolymer, epoxidized soybean oil, chlorinated polyethylene, di-2-ethylhexyl phthalate, di-isoheptyl phthalate, di-isoundecyl phthalate, di-isotridecyl phthalate, di-isononyl-cyclohexane dicarboxylate, and combinations thereof.
